(19) United States
(12) Patent Application Publication
(10) Pub. No.: US 2010/0167958 A1
(43) Pub. Date: Jul. 1, 2010

(54) TRAPPING OF MICRO AND NANO SCALE OBJECTS BASED ON LOCALIZED SURFACE PLASMON

(75) Inventors: Lih-Yuan Lin, Seattle, WA (US); Xiaoyu Miao, Seattle, WA (US); Suzie Pun, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: WASHINGTON, UNIVERSITY OF, Seattle, WA (US)

(21) Appl. No.: 11/764,644

(22) Filed: Jun. 18, 2007

Related U.S. Application Data
(60) Provisional application No. 60/814,280, filed on Jun. 16, 2006.

(51) Int. Cl. C40B 50/14

(52) U.S. Cl. 506/30; 977/773

(57) ABSTRACT

Methods for optically trapping and manipulating micro- and nano-sized particles by using light to induce localized surface plasmon resonance on metallic surface of a substrate. The method includes the steps of contacting a substrate with a medium having particles suspended therein; focusing a beam of coherent light onto the substrate such that the beam induces surface plasmon resonance; and trapping at least one of the suspended particles using a light induced dielectrophoresis force generated by the surface plasmon resonance.

### CROSS-REFERENCE TO RELATED APPLICATION

This application claims the benefit of U.S. Provisional Application No. 60/814,280, filed Jun. 16, 2006, which application is incorporated herein by reference in its entirety.

### STATEMENT OF GOVERNMENT LICENSE RIGHTS

This invention was made with government support under Contract No. DBI 0454324 awarded by the National Science Foundation and Contract No. 1R21EB005183 awarded by the National Institute of Health. The government has certain rights in the invention.

### BACKGROUND OF THE INVENTION

Non-invasive manipulation of single micro- and nano-sized particle is an important tool, for example, in basic biological research and biotechnology, such as constructing biofilms and human tissue engineering. In biological application, small particle manipulation allows cells, cellular components and synthetic marker particles treated with biochemical tags to be collected, separated, concentrated, and/or transported without damage to the objects themselves. The technology is also useful for nano-fabrication, such as aligning nanotubes and other nanoscale objects.

Optical tweezers have been a powerful tool since its invention by Arthur Ashkin at AT&T Bell Laboratories in the early 1970s. The technique has been applied to biological particles such as virus, bacteria, single living cells, and organelles within cells. In addition, the technique has the potential to be used to uncoil and stretch DNA strands, which are several orders of magnitude smaller than cells.

For conventional optical tweezers, an optical trap is formed by tightly focusing a laser beam with an objective lens of high numerical aperture. The resulting optical radiation force can decomposed into the scattering force in the direction of the light propagation and the gradient force in the spatial light gradient. A Gaussian mode can be focused to the smallest diameter beam waist and produce the most efficient trap there.

One drawback of current optical trapping technology has been the required high optical intensity of the trapping light which can damage photo-sensitive particles. In practice, the damage induced by the intense trapping light limits the exposure time for trapping specimens and has proven to be a significant problem for biological studies. In conventional optical traps, the optical intensity required increases as the particle size decreases.

Recent research has been directed to rotating microparticles and biological cells using optical tweezers by modifying the optical beam. Examples include optical line tweezers, which are optical tweezers that use a cylindrical lens in the path of the trapping beam so that the beam profile is shaped elliptically. However, like other conventional optical tweezers approaches, these methods require high optical intensity, which could damage photosensitive particles, such as the biological cells.

Therefore, there is a need for a method of trapping micro scale or nano scale particles with low optical intensity requirement and fine orientation control. The present invention seeks to fulfill these needs and provides further related advantages.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present invention provides methods for manipulating a particle.

In one embodiment, the method comprises,

(a) forming an array of metallic nanoparticles;

(b) contacting the array of metallic nanoparticles with a fluid medium having particles suspended therein;

(c) focusing a beam of coherent light onto the array of metallic nanoparticles such that the beam induces localized surface plasmon resonance; and

(d) trapping at least one of the suspended particles using a light induced dielectrophoresis force generated by the localized surface plasmon resonance.

In one embodiment, the array of metallic nanoparticles comprises cap-shaped nanoparticles. In one embodiment, the metallic nanoparticles nanoparticles comprise gold. In one embodiment, the array of metallic nanoparticles are formed by adsorbing a plurality of polystyrene spheres onto a substrate and depositing a metallic layer onto the polystyrene spheres.

In one embodiment, the method comprises,

(a) forming an array of metallic nanoparticles;

(b) contacting the array of metallic nanoparticles with a fluid having particles suspended therein;

(c) focusing a beam of polarized light onto the array of metallic nanoparticles such that the beam induces localized surface plasmon resonance;

(d) trapping at least one of the suspended particles using a light induced dielectrophoresis force generated by the localized surface plasmon resonance; and

(e) orienting the trapped particle by controlling the direction of polarization of the polarized light.

In one embodiment, the resolution of orienting the suspended particle is better than about 1°.

In one embodiment, the method comprises,

(a) contacting a substrate with a fluid medium having particles suspended therein;

(b) focusing a beam of coherent light onto the substrate such that the beam induces surface plasmon resonance; and

(c) trapping at least one of the suspended particles using a light induced dielectrophoresis force generated by the surface plasmon resonance.

In one embodiment, the method comprises,

(a) contacting a medium with a substrate, wherein a particle is suspended in the medium;

(b) focusing a beam of polarized light onto the substrate, wherein the beam induces surface plasmon resonance, therefore, creates plasmon radiation field; and

(c) orienting the particle by controlling the direction of polarization of the polarized light.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a graphic illustration showing the manipulation of small particles using a localized surface plasmon radiation field;

FIGS. 2A, 2B, 2C, and 2D are graphic illustrations of the fabrication procedure of cap-shaped gold nanoparticles: FIG. 2A illustrates the evaporation of 2-nm chromium and 20-nm gold on the glass coverslip; FIG. 2B illustrates exposure to a polystyrene sphere suspension for adsorption of spheres for one hour; FIG. 2C illustrates the removal of non-adsorbed polystyrene spheres and drying of the surface; and FIG. 2D illustrates the evaporation of another layer of gold on top of the polystyrene spheres;

FIG. 3 is a schematic of the cap-shaped gold nanoparticle array, where gold covers only a top side of the polystyrene spheres; and

FIG. 4 shows the experimental configuration for demonstrating the trapping of tracer particles.

### DETAILED DESCRIPTION OF THE INVENTION

The present invention provides a novel approach for optical trapping and/or other manipulation of micro- and nano-sized particles. The disclosed method uses light to excite resonant oscillating dipoles on one or more metallic nanoparticles. The manipulation of the particles is achieved using a focused laser beam with low intensity to induce localized surface plasmon resonance in one or more of the nanoparticles. As discussed below, the orientation of the particles can be controlled by adjusting laser polarization. The methods of the present invention fundamentally differ from conventional optical tweezers in its underlying physical principle by utilizing a resonant scattering field to create radiation force through localized surface plasmon radiation.

Surface plasmons consist of resonant dipole moments, known as Hertzian dipoles, since its magnitude is smaller than the radiative wavelength. The direction of the Hertzian dipoles is parallel to the electric-field polarization of the incident light. These dipoles radiate in the same way as oscillating charges, and create a patterned radiation electric field with high gradient that may be used to trap and otherwise manipulate micro- and nano-sized particles through dielectrophoresis. In addition to trapping the particles, changing the polarization of the incident light, the radiation pattern can be changed to achieve fine orientation control. The magnitude of the Hertzian dipoles is much smaller than the radiated wavelength. This results in a large electric field gradient, and therefore a relatively high dielectrophoresis force can be generated using a light beam having a relatively low optical intensity.

Localized surface plasmons are electron oscillations confined to metallic nanostructure. The conduction electrons inside the nanostructure move upon light excitation, leading to the buildup of polarized charges on the surface. These charges act as an effective restoring force, which allows for a resonance to occur at a specific frequency. The resonance results in strong enhanced absorption and scattering cross sections for electromagnetic waves, as well as a strongly enhanced near field in the vicinity of the surface. As noted above, the electric field can be used to manipulate and orient micro- and nano-sized particles through dielectrophoresis.

One advantage of the present invention over conventional optical tweezers is that lower optical intensity is required to manipulate the particle, especially when the particle size becomes smaller. This allows applications in trapping and manipulating particles such as viruses, proteins, DNA and RNA with low optical intensity, which reduces the risk of photodamage and makes the present invention more biocompatible compared to conventional optical tweezers.

In one aspect, the present invention provides methods for manipulating a particle.

In one embodiment, the method comprises the steps of,

(a) contacting a medium with a conductive substrate, wherein a particle is suspended in the medium;

(b) focusing a beam of polarized light onto the substrate, wherein the beam induces surface plasmon resonance, therefore, creates plasmon radiation field; and

(c) trapping the particle by the plasmon radiation field.

The substrate of the methods in the present invention can include an array comprising a plurality of metallic nanoparticles. In one embodiment, the nanoparticles are formed by depositing metallic surface on spheres made of other suitable material, such as polystyrene. The array can be a random array, or an array with a well defined pattern. In one embodiment, the nanoparticle has a radius from about 70 nm to about 1500 nm. In one embodiment, the nanoparticle has a radius from about 85 nm to 1000 nm. In one embodiment, the nanoparticle has a radius from about 200 nm to about 500 nm.

In one embodiment, the method comprises the steps of,

(a) forming an array of metallic nanoparticles;

(b) contacting the array of metallic nanoparticles with a medium having particles suspended therein;

(c) focusing a beam of coherent light onto the array of metallic nanoparticles such that the beam induces localized surface plasmon resonance; and

(d) trapping at least one of the particles using a light induced dielectrophoresis force generated by the localized surface plasmon resonance.

The packing of the nanoparticles in the array have varied density. In one embodiment, the array is closely packed.

Localized Surface Plasmon Resonance (LSPR) of Noble Metal Nanoparticles

A. Localized Surface Plasmon Resonance

The resonant electromagnetic behavior of noble metal nanoparticles can be explained by the collective oscillation of the confined conduction electrons. For nanoparticles that are small compared to the wavelength of the exciting light, all of the electrons confined in the nanoparticle experience the same electric field and therefore move in-phase. The displacement of the electron cloud under the effect of an external electric field leads to the creation of surface charges, positive where the electron cloud is lacking and negative where it is accumulating.

The dipolar charge separation imposes an effective restoring force on the electron cloud which conflicts with the external field. The motion of electron cloud can then be modeled as a damped harmonic oscillator driven by the external force. The position x of an electron placed in the oscillating electron cloud of a nanoparticle is then governed by,

$${m}_{e} \frac{{d}^{2} x}{d {t}^{2}} + {m}_{e} Γ \frac{d x}{d t} + Kx = eE \qquad ( 1 )$$

where mₑ and e are the mass and charge of single electron, Γ is the damping factor and E is external electric field. The solution of such an equation is well-known and given by,

$$x = \frac{eE}{{m}_{e} ( {ω}_{R}^{2} - {ω}^{2} - i Γω )} \qquad ( 2 )$$

where ω_{R} is the eigen-frequency of the system given by ω_{R}=mₑ/K. The resonance occurs at ω=ω_{R}, where the response of the electrons shows a π/2 phase lag with respect to the driving field. Thus, a resonantly enhanced field builds up inside the particle, which in the small particle limit is homogeneous throughout its volume. This leads to enhanced far-field scattering and absorption cross sections, as well as a strongly enhanced near field in the immediate vicinity of the particle surface. Generally speaking, the position of the resonance is dependent on the size and shape of the nanoparticle, as well as the dielectric properties of the external medium.

Mie theory provides a solution to this problem in the case of spherical particles by solving Maxwell's equation for the scattering of electromagnetic waves by nanospheres. In Mie theory, the far-field scattering efficiency, which is defined as the ratio of the scattered power in far-field and the incident power at the cross section of the nanosphere, is given in the form of the following infinite series,

$${Q}_{fscat} = \frac{2}{{( ka )}^{2}} {\sum }_{n = 1}^{∞} ( 2 n + 1 ) ( {\vert {a}_{n} \vert}^{2} + {\vert {b}_{n} \vert}^{2} ) \qquad ( 3 )$$

where k is the wave number, a is the radius of the nanosphere, aₙ and bₙ are Mie scattering coefficients. Physically, Q_{fscat} is a measure of the ability of a metal nanosphere to extract power from an incident wave and redirect it as far-field scattered power over all solid angles. In the near-field region, the outgoing electromagnetic waves must be significantly distorted compared to the far-field in order to satisfy the boundary conditions at the perfect conductor surface. Therefore, the radial components must be included in the near field of the nanosphere while the far field only consists of perpendicular components to the radial direction. A near-field scattering efficiency is defined in the similar way but evaluating the electric-field intensity at the surface of the sphere, which is given by,

$${Q}_{nscat} = 2 {\sum }_{n = 1}^{∞} \{ \begin{matrix}\vert {a}_{n}^{2} \vert [ \begin{matrix}( n + 1 ) \vert {h}_{n - 1}^{( 2 )} ( ka ) {\vert}^{2} + \\ n \vert {h}_{n + 1}^{( 2 )} ( ka ) {\vert}^{2}\end{matrix} ] + \\ ( 2 n + 1 ) \vert {b}_{n}^{2} \vert \vert {h}_{n}^{( 2 )} ( ka ) {\vert}^{2}\end{matrix} \} \qquad ( 4 )$$

where hₙ⁽²⁾ is the Hankel function of the second kind. Both the far-field and near-field scattering resonance peaks experience a red shift as the size of nanosphere increases.

B. Dipolar Polarizability

The dipole momentum of an excited gold nanosphere can be related to the incident electric field by the dipolar polarizability, which is given by,

$${α}_{dip} = \frac{i 6 π {a}_{1} {ɛ}_{m}}{{k}^{3}} \qquad ( 5 )$$

where aₗ is the first term of Mie scattering coefficients, ∈ₘ is the permittivity of the medium, and k is the wave number. For example, a gold nanosphere with the radius 70 nm immersed in water has a far-field scattering peak (determined from the real part of the dipolar polarizability) that occurs at the wavelength of HeNe laser (633 nm).

Assuming the scattering far field is only contributed by the dipolar radiation, the magnitude of the dipolar polarizability of the gold nanosphere can also be determined from the far-field scattering efficiency, which is given by,

$$\vert {α}_{dip} \vert = \frac{\sqrt{6 {Q}_{fscat}} π R {ɛ}_{m}}{{k}^{2}} \qquad ( 6 )$$

The peak values of the dipolar polarizability calculated through the two different approaches varies less than 0.3% and both the peaks occur at the same incident wavelength. This suggests that for such a gold nanosphere at the resonance condition, the dipolar radiation dominates in the scattering far field and the multipole components are almost negligible.

C. Mie Scattering Field and Dipolar Approximation

Consider the scattering of a linearly polarized plane wave by a gold nanosphere immersed in water. For convenience, we select the origin of a Cartesian coordinate system to be at the center of the sphere, with the positive z axis along the direction of propagation of the incident wave. The incident electric vector is polarized in the direction of the x axis. If the amplitude of the incident wave at the origin is E₀, the scattering field can be expressed in the form,

$$\vec{{E}_{s}} = {\sum }_{n = 1}^{∞} {E}_{n} [ i {a}_{n} \vec{{N}_{e 1 n}} - {b}_{n} \vec{{M}_{01 n}} ] \qquad ( 7 )$$

In Eqn. (7), Eₙ=iⁿ (2n+1)/[n(n+1)]E₀, aₙ and bₙ are the Mie scattering coefficients, and the vector spherical harmonics are given by,

$$\vec{{N}_{e 1 n}} = cos ϕ n ( n + 1 ) sin {δπ}_{n} ( cos δ ) {h}_{n}^{( 1 )} ( kr ) / ( kr ) \hat{r} + cos {{ϕτ}_{n} ( cos δ ) [ {krh}_{n}^{( 1 )} ( kr ) ]}^{′} / ( kr ) \hat{δ} - sin {{ϕπ}_{n} ( cos δ ) [ {krh}_{n}^{( 1 )} ( r ) ]}^{′} / ( kr ) \hat{ϕ} \\ \vec{{M}_{01 n}} = cos {ϕπ}_{n} ( cos δ ) {h}_{n}^{( 1 )} ( kr ) \hat{δ} - sin {ϕτ}_{n} ( cos δ ) {h}_{n}^{( 1 )} ( kr ) \hat{ϕ} \qquad ( 8 )$$

where hₙ⁽¹⁾ is the Hankel function of the first kind, πₙ=Pₙ¹/sin δ and τₙ=dPₙ¹/dδ with Pₙ¹ the associated Legendre functions of the first kind of degree n and order 1.

For a nanosphere with the size small compared to the wavelength, the scattering field can be approximately seen as radiated from an infinitely small Hertzian dipole located at the center of the gold nanosphere. The direction of the Hertzian dipole is parallel to the electric-field polarization of the incident wave. The equivalent polarization momentum of the Hertzian dipole can be related to the incident electric field by the dipolar polarizability of the Au nanosphere. The radiation field from this dipole is described by,

$${\overline{E}}_{r} = \frac{1}{4 {πɛ}_{m}} \{ \frac{{k}^{2}}{r} \hat{r} \times p \times \hat{r} + ( \frac{1}{{r}^{3}} - \frac{i k}{{r}^{2}} ) [ 3 \hat{r} ( \hat{r} \cdot p ) - p ] \} {e}^{i kr} \qquad ( 9 )$$

The resonant scattering field from a gold nanosphere is quite non-uniform, which decays rapidly when the radial distance increases. Such a non-uniform electric field will exert a gradient force on another Rayleigh dielectric particle close to the nanosphere. Since the dipole model is a good approximation for Mie scattering when the nanosphere is small in size compared to the wavelength, it is straightforward to apply the simpler expression in Eqn. (9) to analyze the induced gradient force from Mie scattering field.

D. Optical Force in Far-Field Regime

The magnitude of the electric field in far-field regime can be written as,

$${E}_{f} = \frac{{k}^{2} \vert {α}_{dip} \vert {E}_{0} sin θ}{4 {πɛ}_{m} r} \qquad ( 10 )$$

where θ is the intersection angle between the radial vector and the polarization vector. The far scattering field intensity decays as the radial distance increases. The exerted gradient force on a Rayleigh dielectric particle in far-field regime can be calculated by the following expression,

$$\vec{{F}_{f}} = \frac{1}{2} {α}_{p} \vec{∇} {E}_{f}^{2} = \frac{{α}_{p} \vert {α}_{dip} {\vert}^{2} {E}_{0}^{2} {k}^{4}}{32 {π}^{2} {ɛ}_{m}^{2}} ( - \hat{r} \frac{2}{{r}^{3}} {sin}^{2} θ + \hat{θ} \frac{2}{{r}^{3}} sin θ cos θ ) ≡ {F}_{fr} \hat{r} + {F}_{f θ} \hat{θ} \qquad ( 11 )$$

where αₚ is the polarizability of the dielectric particle. As shown in Eqn. (11), the optical radiation force in scattering far field consists of two components: radial force Fᵣ and angular force F_{θ}. The radial component points towards the radiation source and the force magnitude increases when the dielectric particle gets closer to the source. The direction of the angular force is determined by the sign of sin θ cos θ. The angular force is in the +\hat{θ} direction for 0°<θ<90° and 180°<θ<270°, and the −\hat{θ} direction for 90°<θ<180° and 270°<θ<360°. The angular force points towards the θ=90° equator and reaches zero at this equator plane. The combinational effect of these two force components will pull the dielectric particle towards the angular force valley and align the particle to the θ=90° equator.

E. Optical Force in Near-Field Regime

In the near-field regime, the magnitude of the electric field can be expressed by,

$${E}_{n} = \frac{\vert {α}_{dip} \vert {E}_{0} \sqrt{( 3 {cos}^{2} θ + 1 ) ( 1 / {r}^{2} + {k}^{2} )}}{4 {πɛ}_{m} {r}^{2}} \qquad ( 12 )$$

The magnitude of the radiation electric field is much larger than that in far-field regime, and decays much faster. The associated gradient force exerted on another Rayleigh particle in the near-field regime is given by,

$$\vec{{F}_{n}} = \frac{1}{2} {α}_{p} \vec{∇} {E}_{n}^{2} = \frac{{α}_{p} {α}^{2} {E}_{0}^{2}}{32 {π}^{2} {ɛ}_{m}^{2}} [ \begin{matrix}- \hat{r} ( \frac{6 + 4 {k}^{2} {r}^{2}}{{r}^{7}} ) ( 3 {cos}^{2} θ + 1 ) - \\ \hat{θ} ( \frac{6 + 6 {k}^{2} {r}^{2}}{{r}^{7}} ) sin θ cos θ\end{matrix} ] ≡ {F}_{nr} \hat{r} + {F}_{n θ} \hat{θ} \qquad ( 13 )$$

Here the force is similarly divided into the radial and angular component. The angular force component keeps the same amplitude cross section pattern as in the far field, while the radial force component is quite different from that in the far field. The radial force remains pointing toward the nanosphere but the direction of angular force is reversed. The angular force is in the +\hat{θ} direction for 90°<θ<180° and 270°<θ<360° and the −\hat{θ} direction for 0°<θ<90° and 180°<θ<270°. The angular force points towards the θ=0° equator and reaches zero at this equator plane. The force magnitude decreases rapidly with increasing the radial distance. The alignment effect is not as significant as in the far-field regime since the radial force is much larger than the angular force in near-field regime. The trapped particle is almost directly pulled toward the radiation source.

The Surface Plasmon Resonance of Cap-Shaped Gold Nanoparticle Array

In one embodiment, the array of metallic nanoparticles comprises cap-shaped nanoparticles. In one embodiment, the cap-shaped nanoparticles comprise gold.

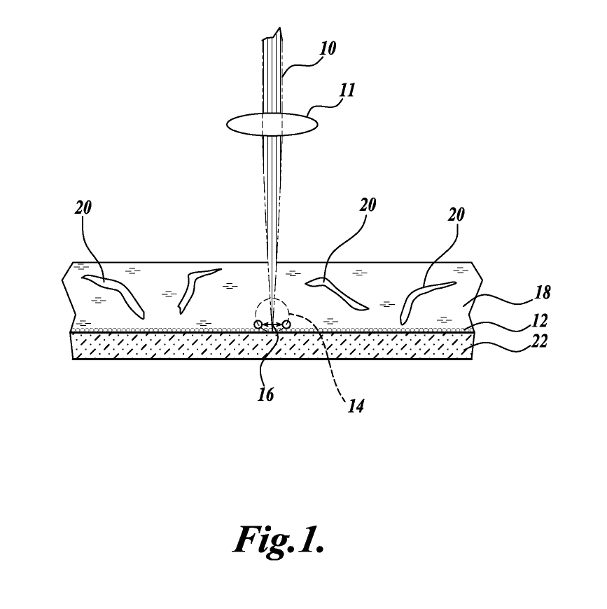

As illustrated in FIG. 1, incident light induces resonant localized surface plasmons on cap-shaped gold nanoparticles.

A relatively low intensity beam of light 10 is focused 11 on a substrate having an array of gold nanoparticles 12, to generate a local dipole field 14 through local surface plasmon resonance 16. A fluid medium 18, for example, water or air, is disposed over the array of nanoparticles 12, and may be in motion. Small particles 20, for example, biological particles such as viruses, proteins, DNA or RNA, are suspended in the fluid medium

A. Fabrication of Cap-Shaped Gold Nanoparticles

The array of metallic nanoparticles in the method of the present invention can be formed by adsorbing a plurality of polystyrene spheres onto a substrate and depositing a metallic layer onto the polystyrene spheres. In one embodiment, the metallic layer is deposited on the polystyrene spheres by vacuum deposition. In one embodiment, the array of metallic nanoparticles comprise a noble metal. In one embodiment, the array of metallic nanoparticles comprise gold.

An exemplary method for forming the array of gold particles 12 will now be described. It is contemplated that other methods for fabricating suitable arrays of metallic nanoparticles may be used without departing from the present invention. The cap-shaped gold nanoparticle array 12 may be formed using surface-adsorbed polystyrene spheres as a template. The use of monodisperse polystyrene spheres covering a wide range of area permits the production of equally monodisperse gold nanostructure.

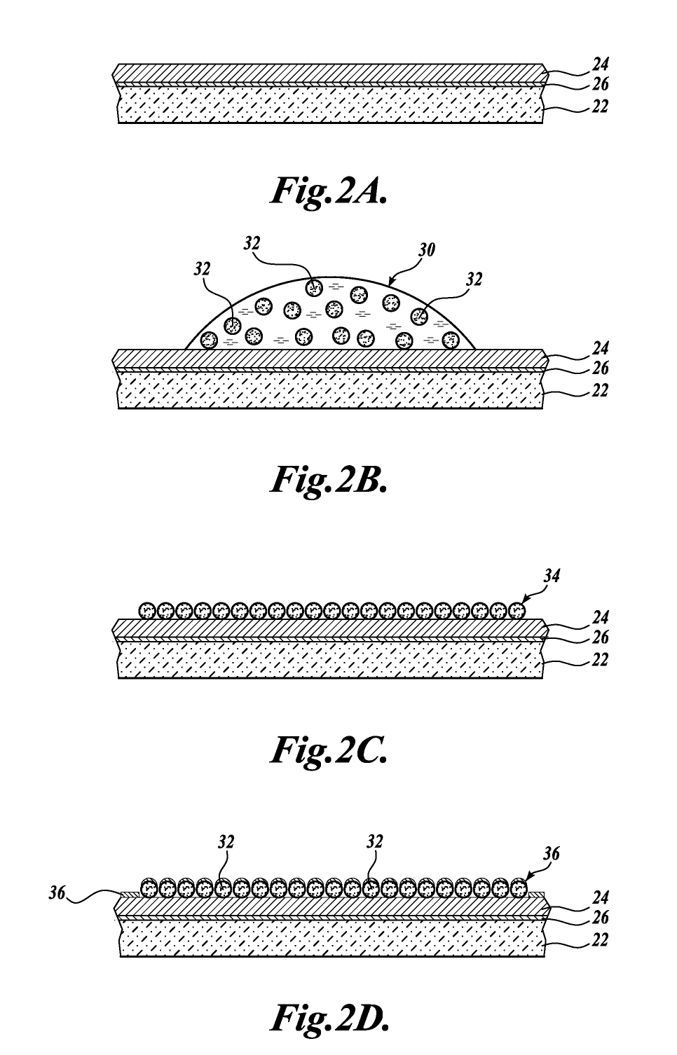

The present procedure to fabricate an array 12 of cap-shaped gold nanoparticles, i.e., gold nanoshell film, is illustrated graphically in FIGS. 2A-2D, and begins with cleaning a glass coverslip 22 with acetone, isopropyl alcohol, and de-ionized water followed by drying with nitrogen gas. Afterward, the glass coverslip is evaporated with gold 24 in a vacuum of 5×10⁻⁶ Torr at a rate of 1 Å/sec to a final thickness of 20 nm using chromium 26 as the adhesion layer. At the meantime, a mixture solution 30 is prepared by mixing 100 mM phosphate buffer containing 15 mM carbodiimide (EDC), 10% polystyrene sphere 32 suspension and de-ionized water with the volume ratio 2:1:2. The mixture solution is then deposited to the surface of gold film 22 using the drop coating technique. To assure consistency in the sample quality, the adsorption process is allowed to continue for about one hour. Non-adsorbed spheres 32 are washed away with a copious amount of de-ionized water; subsequently, the self-assembled polystyrene monolayer 34 is allowed to dry in air. Once dried, the array of spheres 34 are firmly adsorbed on the gold substrate 24 such that vigorous squirting of water from a wash bottle dislodges very few spheres. Finally, another 20 nm of gold 36 is evaporated on the sphere monolayer and forms the cap-shaped gold nanoparticle array.

B. Characterization of Cap-Shaped Gold Nanoparticles

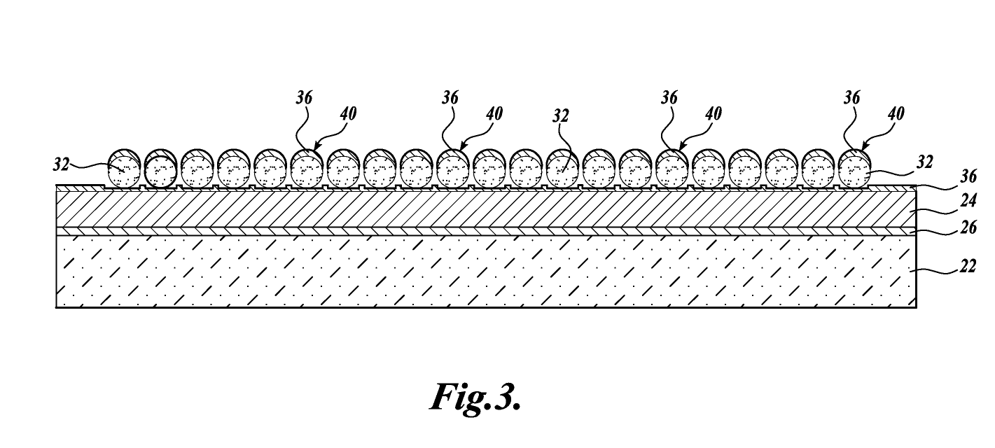

By following the above procedure, the cap-shaped gold nanoparticles using polystyrene spheres with the size varying between 85 nm and 1000 nm fabricated. Gold 36 is found to cover only the top sides of the spheres 32. The region directly below a sphere 32 is clearly shadowed, which is illustrated in FIG. 3. The boundary between gold coated region and non-coated region can be discerned by observation with the sample tilted. Furthermore, the spherical shape is remained after evaporation, showing no sign of deformation as a result of heat from the evaporation source. The cap-shaped gold nanoparticles 40 are closely packed without forming the clusters.

Typical scattering spectra of the cap-shaped gold nanoparticle array formed with 209-nm and 454-nm show that the scattering peak of the nanoparticles experiences a red shift when the size increases. The scattering efficiency of the cap-shaped gold nanoparticles is characterized by measuring the ratio between the scattered light power and incident light power at the resonance peak wavelength. The results based on the spectral measurement give an estimation of scattering efficiency to be 6.39% and 22.78% for the close-packed gold nanoparticle array formed with the 209-nm and 454-nm polystyrene sphere templates, respectively. As noted above, the scattering efficiency represents the ability of the nanoparticle array to extract power from an incident wave and redirect it as scattered power over all solid angles. Therefore, a higher scattering efficiency will result in lower optical intensity requirement in terms of trapping based on the resonant scattering field from the nanoparticles.

C. Trapping Demonstration

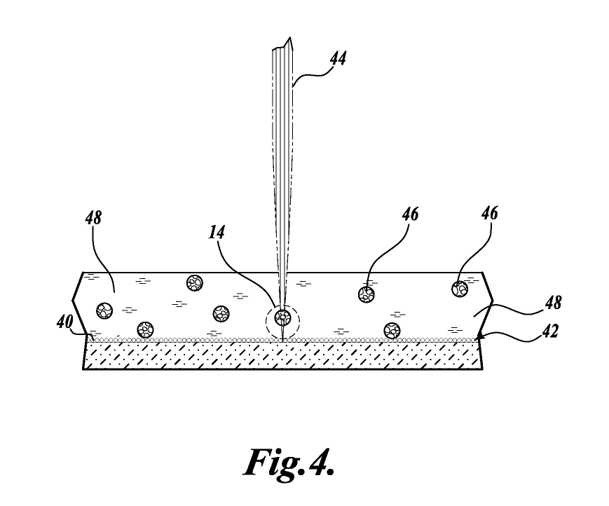

Referring now to FIG. 4, a cap-shaped gold nanoparticle array 42 formed with 454-nm polystyrene sphere template is used as the platform to excite the localized surface plasmons. This is because the resonance scattering peak of this array is close to 633 nm, which is the wavelength of HeNe laser 44. A drop of diluted polystyrene tracer 46 suspension with volume 1 μl is added onto the surface of cap-shaped gold nanoparticle array 42 formed with the 454-nm polystyrene sphere template. A sealed chamber and the thin liquid layer 48 are formed by putting a spacer onto the nanoparticle array 42 followed by adding a glass coverslip on top. This prevents the liquid evaporation and allows the experiment to last for several hours. Furthermore, the formed thin liquid layer makes it easy to focus the laser light as compared to the liquid drop with the hemispherical top surface. An epi-illumination fluorescence microscope is used to observe the motions of polystyrene tracers in the liquid layer. A HeNe laser 44 is directed into the optical path of the microscope without compromising the original imaging capability. This is achieved by using a dichroic mirror (not shown), which reflects the laser light but transmits the light used for microscope illumination. The laser beam 44 is then focused onto the surface of gold nanoparticle array 42 by the microscope objective. The experimental results suggest that single polystyrene tracer particles 46 can be steadily trapped by the plasmon radiation field.

As shown in FIG. 4, a tracer particle 46 is trapped by the plasmon radiation field when the excitation source is turned on. When the motorized stage of the microscope is moved, the fluid flow exerts a viscous drag force on the trapped particle. The trapped tracer particle remains at the original location when the flow rate is smaller than a certain value. This indicates that the trapping force overcomes the viscous drag force and the Brownian motion. However, this trap can be lost if the flow rate keeps increasing. It is meaningful to measure the minimum flow rate of the surrounding fluid, at which the tracer particle is released from the trap.

With the same incident optical intensity provided, the plasmon radiation field generates more stable traps for smaller particles, which require higher external flow rate in order to release the trapped particle. The approximate linear relationship between the reciprocal of the change in critical flow rate and particle size is shown in the following analysis.

The optical force in far-field regime makes most significant contribution for trapping the micron scale particles. The dipole-field induced horizontal trapping force, which pulls the particle back to the original location, can be calculated by,

$${F}_{trap} = {F}_{fr} cos θ + {F}_{f θ} sin θ = \frac{{α}_{p} \vert {α}_{dip} {\vert}^{2} {E}_{0}^{2} {k}^{4}}{16 {π}^{2} {ɛ}_{m}^{2} {r}^{3}} {sin}^{2} θ cos θ \qquad ( 14 )$$

This force can be further expressed by as a function of incident optical intensity I₀, which is given by,

$$\begin{matrix}{F}_{trap} = {F}_{fr} cos θ + {F}_{f θ} sin θ \\ = \frac{{α}_{p} {n}_{m} {I}_{0} \vert {α}_{dip} {\vert}^{2} {k}^{4}}{8 {π}^{2} {cɛ}_{m}^{3} {r}^{3}} {sin}^{2} θ cos θ\end{matrix} \qquad ( 15 )$$

By substituting the detailed expression for polarizability of the tracer particle in terms of the particle diameter d and refractive index nₚ, we obtain,

$$\begin{matrix}{F}_{trap} = {F}_{fr} cos θ + {F}_{f θ} sin θ \\ = \frac{{n}_{m} {I}_{0} \vert {α}_{dip} {\vert}^{2} {d}^{3} {k}^{4} ( {n}_{p}^{2} - {n}_{m}^{2} )}{16 π {cɛ}_{m}^{2} {r}^{3} ( {n}_{p}^{2} + 2 {n}_{m}^{2} )} {sin}^{2} θ cos θ\end{matrix} \qquad ( 16 )$$

When the flow rate is at the critical value, the horizontal trapping force can be estimated by the viscous drag force, which can be evaluated by,

f_{drag}=3πηdV_{c} (17)

where η is the viscosity of the liquid, d is the diameter of the tracer particle and V_{c} is the critical flow rate to release the trapped particle.

By relating Eqn. (16) and Eqn. (17) to each other, the reciprocal of the change of critical flow rate can be expressed by,

$$\frac{\partial {I}_{0}}{\partial {V}_{c}} = ( \frac{{r}^{3}}{{d}^{2}} ) \frac{48 {π}^{2} c {ηɛ}_{m}^{2} ( {n}_{p}^{2} + 2 {n}_{m}^{2} )}{{n}_{m} \vert {α}_{dip} {\vert}^{2} {k}^{4} ( {n}_{p}^{2} - {n}_{m}^{2} ) ( {sin}^{2} θ cos θ )} \qquad ( 18 )$$

When a stable trap is formed for the tracer particle, the particle radius can be used as the approximate estimation for the radial distance r in Eqn. (18). Therefore, Eqn. (18) can be simplified as,

$$\frac{\partial {I}_{0}}{\partial {V}_{c}} \approx \frac{6 {π}^{2} c d {ηɛ}_{m}^{2} ( {n}_{p}^{2} + 2 {n}_{m}^{2} )}{{n}_{m} \vert {α}_{dip} {\vert}^{2} {k}^{4} ( {n}_{p}^{2} - {n}_{m}^{2} ) ( {sin}^{2} θ cos θ )} \qquad ( 19 )$$

Eqn. (19) indicates the approximate linear relationship between ∂I₀/∂V_{c}, and the particle size d.

The cap-shaped nanoparticles in the present invention can be at varied sizes. In one embodiment, the cap-shaped nanoparticles are formed on spheres having a radius from about 60 nm to about 1000 nm In one embodiment, the cap-shaped nanoparticles have an approximately spherical outer surface with a radius between about 60 nm and 1000.

The substrate in the method of the present invention can also be a metallic surface. The metallic surface can be a surface made from any conductive material, such as gold or silver. In one embodiment, the surface is a metallic film laid on top of a solid base.

It has been unexpectedly discovered that using nanoparticles instead of thin films would generate enhanced scattering electrical field through localized surface plasmon resonance (LSPR) with any light incident angle, as oppose to a specific angle in the thin film case. In one embodiment, the surface plasmon resonance in the present invention has a resonant wavelength more than about 600 nm and is tunable.

The particle in the methods of the present invention can be suspended in a liquid or gaseous medium. For example, the particle could be a virus, a cell, a bacterial, an antibody, a DNA, or a protein suspended in a biological liquid, or in a gas.

The particle that could be manipulated by the methods in the present invention can be any molecule of micro- or nano-size. The representative particle include biomolecules such as proteins, antibodies, nucleic acids, cells, cell organelles, viruses, bacterial, etc.

In one embodiment, the method of the present invention could further include the step of adjusting the polarization direction of the incident light with a micromachined polarization controller. The methods of the present invention achieve fine orientation control of a particle by changing the polarization direction of the light.

In one embodiment, the method of the present invention includes the steps of,

(a) contacting a medium with a substrate, wherein a particle is suspended in the medium;

(b) focusing a beam of polarized light onto the substrate, wherein the beam induces surface plasmon resonance, therefore, creates plasmon radiation field; and

(c) orienting the particle by controlling the direction of the polarization of the polarized light.

In one embodiment, the method of the present invention includes the steps of,

(a) forming an array of metallic nanoparticles;

(b) contacting the array of metallic nanoparticles with a fluid having particles suspended therein;

(c) focusing a beam of polarized light onto the array of metallic nanoparticles such that the beam induces localized surface plasmon resonance;

(d) trapping at least one of the particles using a light induced dielectrophoresis force generated by the localized surface plasmon resonance; and

(e) orienting the trapped particle by controlling the direction of the polarization of the polarized light.

Fine control of the micro- or nano-sized particles by the methods of the present invention can be achieved. In one embodiment, the resolution of orienting the particle is better than about 1°.

In one embodiment, the method of the invention includes the steps of,

(a) contacting a medium with a substrate;

(b) inducing an oscillating dipole moment on the substrate with an incident light;

(c) creating a patterned radiation electric field with the oscillating dipole moment; and

(d) trapping and orientating the particle with the patterned radiation electric field through dielectrophoresis.

In one embodiment, the method of the invention includes the steps of,

(a) contacting a substrate with a fluid medium having particles suspended therein;

(b) focusing a beam of coherent light onto the substrate such that the beam induces surface plasmon resonance; and

(c) trapping at least one of the particles using a light induced dielectrophoresis force generated by the surface plasmon resonance.

In one embodiment, the method of the invention includes the steps of,

(a) contacting a medium with a substrate, wherein a particle is suspended in the medium;

(b) focusing a beam of polarized light onto the substrate, wherein the beam induces surface plasmon resonance, therefore, creates plasmon radiation field; and

(c) orienting the particle by controlling the direction of polarization of the polarized light.

The present invention could also be used in sorting particles according to the particle size.

Contrary to the conventional optical tweezers technology in the field, the methods in the present invention generate stronger trapping force for smaller particles. Not wanting to be limited by the theory, it is believed that smaller particles are capable of being closer to the surface, therefore, experience stronger plasmon radiation field. The present invention achieves selectively retention of smaller particles, therefore, sorting according to size by controlling the flow rate of the medium, therefore, creating drag force on the particles with varied strength.

The methods of the present invention can be used to sort particles with a size ranging from about 100 nm to about 2 micron. The representative particles that could be sorted by using the methods in the present invention include DNA, protein, cells, cell organelles etc.

In another aspect, the present invention provides devices for manipulating a particle.

In one embodiment, the device includes,

(a) an array, wherein the array comprises a plurality of nanoparticles, and wherein the nanoparticle is at least partially covered with a metal;

(b) a medium in contact with the array, wherein a particle is suspended in the medium;

(c) a polarized light source for generating a beam of polarized light; and

(d) a means for focusing the beam of polarized light onto the substrate, wherein the beam induces surface plasmon resonance, therefore, creates a plasmon radiation field.

### EXAMPLES

### Example 1

### Fabrication of Au Nanoshell Films

The Au nanoshell film is formatted using surface-adsorbed polystyrene spheres as a template. The use of monodisperse polystyrene spheres covering a wide range of sizes permits the production of equally monodisperse Au nanostructures. The procedure (shown in FIG. 8) to build the Au nanoshell film begins with cleaving a small coupon, generally 1 cm×1 cm area, from a silicon wafer (Ultrasil Corporation, Hayward, Calif.). The sample is cleaned by rinsing with xylene, acetone, isopropyl alcohol (IPA) and de-ionized (DI) water followed by drying with nitrogen gas. Then, the sample is evaporated with Au in a vacuum of 5×10⁻⁶ Torr at a rate of 1 Å/s to a final thickness of 20 nm using Cr as the adhesion layer. The next step is to prepare the sphere solution 100 mM phosphate buffer (pH=7.6) (Sigma-Aldrich, St. Louis, Mo.) containing 15 mM carbodiimide solution (1-ethyl-3-(3-(dimethylamino)propyl)carbodiimide, Sigma-Aldrich, St. Louis, Mo.) and polystyrene suspension (Polysciences, Inc., Warrington, Pa. or Spherotech, Inc., Libertyville, Ill.) were mixed and further diluted with deionized water. The sphere suspension is then deposited to the surface of the Au layer. The sphere adsorption begins immediately upon exposure of the substrate to the sphere suspension. To assure consistency in the sample quality, the adsorption process was allowed to continue for about 1 hour. Non-adsorbed spheres are washed away with a copious amount of deionized water; subsequently the formed monolayer of polystyrene sphere is allowed to dry in air. Once dried, the spheres will be firmly adsorbed such that vigorous squirting of water from a wash bottle dislodged very few spheres. At the final step, another 20 nm of Au is evaporated on the sphere monolayer and forms the Au nanoshell film.

### Example 2

### Thermal Evaporation of Au

For evaporation a thermal evaporator (Auto 306 Vacuum Coating Systems, BOC Edwards Group Inc., Wilmington, Mass.) was used at a base pressure of 2×10⁻⁶ Torr; the growth rate was monitored by a quartz crystal microbalance and manually adjusted to 1 Å/s. Gold of 99.95% purity was obtained from. 20 nm of Au were evaporated onto the Si coupon for preparation of Au substrates. The same amount of Au was evaporated onto the adsorbed polystyrene spheres for the final Au nanoshell formation.

### Example 3

### Self-Assembly of Polystyrene Spheres

To prepare the sphere suspension, 100 mM phosphate buffer (pH=7.6) containing 15 mM carbodiimide (EDC), polystyrene suspension and deionized water are mixed together at certain ratio in the Eppendorf tube. The sample after Au evaporation is cleaned using oxygen plasma for about 1 minute to remove the organic impurities on the surface. Then the sphere suspension of 25 μl is deposited on the surface of the sample using a pipette. The suspension forms a hemispherical shape since the surface of the sample is hydrophobic. The sphere adsorption begins immediately upon exposure of the substrate to the sphere suspension. The adsorption process is allowed to continue for about 1 hour. Then the sample is washed by a copious amount of deionized water to remove the non-adsorbed spheres on the surface. Subsequently the sample is dried in the air and the round boundary between the polystyrene sphere monolayer and the remaining Au surface can be clearly seen by eyes. Once dried, the spheres will be firmly adsorbed such that vigorous squirting of water from a wash bottle dislodged very few spheres. Finally both sides of the sample are completely dried using N₂ flow.

### Example 4

### Characterization of Au Nanoshell Film

To check on sample quality in terms of particle density and the monolayer formation, scanning electron microscope, atomic force microscope and conventional optical microscope are used to characterize the sample. It was found that the appropriate mixture ratio for the sphere solution is a critical factor for successful formation of a polystyrene sphere monolayer. Spectrum analysis of the Au nanoshell film using a UV-VIS spectrometer is also performed in order to identify the scattering resonance peak.

While illustrative embodiments have been illustrated and described, it will be appreciated that various changes can be made therein without departing from the spirit and scope of the invention.

1. A method for manipulating a particle, comprising,
(a) forming an array of metallic nanoparticles;
(b) contacting the array of metallic nanoparticles with a fluid medium having particles suspended therein;
(c) focusing a beam of coherent light onto the array of metallic nanoparticles such that the beam induces localized surface plasmon resonance; and
(d) trapping at least one of the suspended particles using a light induced dielectrophoresis force generated by the localized surface plasmon resonance.

2. The method of claim 1, wherein the array of metallic nanoparticles comprises cap-shaped nanoparticles.

3. The method of claim 1, wherein the array is closely packed.

4. The method of claim 1, wherein the array of metallic nanoparticles comprise a noble metal.

5. The method of claim 1, wherein the metallic nanoparticles nanoparticles comprise gold.

6. The method of claim 2, wherein the cap-shaped nanoparticles are formed on spheres having a radius from about 60 nm to about 1000 nm.

7. The method of claim 1, wherein the metallic nanoparticles have an approximately spherical outer surface with a radius between about 60 nm and 1000 nm.

8. The method of claim 1, wherein the array of metallic nanoparticles are formed by adsorbing a plurality of polystyrene spheres onto a substrate and depositing a metallic layer onto the polystyrene spheres.

9. The method of claim 8, wherein the metallic layer is deposited on the polystyrene spheres by vacuum deposition.

10. The method of claim 8, wherein the metallic layer is gold.

11. The method of claim 1, wherein the localized surface plasmon resonance has a resonant wavelength of more than about 600 nm.

12. The method of claim 1, wherein the fluid medium is a liquid.

13. The method of claim 1, wherein the fluid medium is a gas.

14. The method of claim 1, wherein the particles suspended in the fluid are biological particles.

15. The method of claim 14, wherein the suspended particles are nucleic acids.

16. The method of claim 14, wherein the suspended particles are proteins.

17. The method of claim 14, wherein the suspended particles are an antibodies.

18. The method of claim 14, wherein the suspended particles are cells.

19. A method for manipulating a particle, comprising,
(a) forming an array of metallic nanoparticles;
(b) contacting the array of metallic nanoparticles with a fluid having particles suspended therein;
(c) focusing a beam of polarized light onto the array of metallic nanoparticles such that the beam induces localized surface plasmon resonance;
(d) trapping at least one of the suspended particles using a light induced dielectrophoresis force generated by the localized surface plasmon resonance; and
(e) orienting the trapped particle by controlling the direction of polarization of the polarized light.

20. The method of claim 19, wherein the resolution of orienting the suspended particle is better than about 1°.

21. A method for manipulating a particle, comprising,
(a) contacting a substrate with a fluid medium having particles suspended therein;
(b) focusing a beam of coherent light onto the substrate such that the beam induces surface plasmon resonance; and
(c) trapping at least one of the suspended particles using a light induced dielectrophoresis force generated by the surface plasmon resonance.

22. The method of claim 21, wherein the substrate comprises an array of metallic nanoparticles.

23. The method of claim 22, wherein the array of metallic nanoparticles comprise gold.

24. The method of claim 21, wherein the substrate comprises an array of protuberances.

25. The method of claim 21, wherein the substrate comprises an array of spherical nanoparticles.

26. A method for manipulating a particle, comprising,
(a) contacting a medium with a substrate, wherein a particle is suspended in the medium;
(b) focusing a beam of polarized light onto the substrate, wherein the beam induces surface plasmon resonance, therefore, creates plasmon radiation field; and
(c) orienting the particle by controlling the direction of polarization of the polarized light.

27. The method of claim 26, wherein the substrate comprises an array of metallic nanoparticles.

28. The method of claim 26, wherein the substrate comprises an array of spherical protuberances.
